(19) United States
(12) Patent Application Publication
(10) Pub. No.: US 2012/0276783 A1
(43) Pub. Date: Nov. 1, 2012

(54) CONNECTOR HAVING LEAD PINS EXTENDING FROM BOTTOM AND SIDE SURFACES THEREOF

(75) Inventors: Shao-Chun Chang, Taoyuan County (TW); Ching-Feng Hsieh, Taipei (TW)

(73) Assignee: Askey Computer Corporation, New Taipei City (TW)

(21) Appl. No.: 13/164,282

(22) Filed: Jun. 20, 2011

(30) Foreign Application Priority Data
Apr. 28, 2011 (TW) 100114805

(51) Int. Cl. H01R 24/28

(52) U.S. Cl. 439/660

(57) ABSTRACT

A connector for connecting to a printed circuit board, including a connector body and a plurality of lead pins extending from the connector body and soldered onto the printed circuit board. The lead pins extend from a region including a bottom surface of the connector body and a side surface adjacent to the bottom surface, thereby overcoming the drawbacks as encountered in prior techniques including missing and poor soldering during SMT soldering process or the connector falling off from the soldering point in use.

### BACKGROUND OF THE INVENTION

1. Field of the Invention

The present invention relates to connectors, and, more particularly, to a connector that improves the quality of Surface Mount Technology (SMT) soldering.

2. Description of Related Art

In general, Surface Mount Technology (SMT) involves placing a circuit board on a carrier, printing/coating solder on a contact surface of the circuit board, and then disposing and reflowing corresponding lead pins of a semiconductor element or chip against the solder on the contact surface of the circuit board to electrically connect the semiconductor element or chip with the circuit board. It is clear that the design of the lead pins of the semiconductor element or chip is critical to the quality of SMT soldering, and, in turn, the overall quality of the electronic device.

In the prior art, as a result of poor design of the lead pins of semiconductor elements or chips, missing and poor soldering during subsequent soldering processes or elements falling off from soldering points when later in use are common, especially for micro-sized electronic elements used in compact electronic devices, in which the lead pins are usually densely packed and short, resulting in poor soldering. Referring to FIG. 1, a schematic diagram illustrating soldering of a conventional connector is shown. As shown, a circuit board of a Bluetooth module 11 is provided with solder paste 13. A connector 12 includes a connector body 121 and a plurality of lead pins 122 extending from the connector body 121, with each lead pin 122 protruding from the bottom surface of the connector body 121. Upon the lead pins 122 of the connector 12 being in contact with the solder paste 13, surface tension caused by the melted solder paste 13 will act upon the lead pins 122 of the connector 12, thereby soldering the connector 12 on the circuit board of a Bluetooth module 11.

However, it is found that, during the actual SMT solder reflow process, the length of the lead pins 122 protruding from the bottom surface of the connector body 121 is short, that is, the distance between the tip of a lead pin 122 and the bottom surface of the connector body 121 is short, so when the melted solder paste 13 is attempting to act on the lead pins 122 of the connector 12, the solder paste 13 will be disrupted by the connector body 121, resulting in an uneven surface tension. Further, since the solder paste 13 flows from low surface-tension regions to high surface-tension regions, a depression is likely to form on the fluidic solder paste 13, that is, the so-called “Marangoni Effect”, and ultimately forming circular concave towards the center with raised periphery, as shown in FIG. 1. This will reduce the amount of solder paste attached to the lead pins 122, resulting in missing and poor soldering or the connector falling off from the soldering point when later in use.

Therefore, there is a need for a connector that overcomes the shortcomings of the prior art.

### SUMMARY OF THE INVENTION

In the light of forgoing drawbacks, an objective of the present invention is to provide a connector that eliminates the occurrences of missing and poor soldering during SMT soldering processes or the connector falling off from the soldering point when later in use.

In accordance with the above and other objectives, the present invention provides a connector for connecting onto a circuit board, the connector comprising a connector body and a plurality of lead pins extending from the connector body for soldering onto the circuit board, characterized by: the lead pins extending from a region including the bottom surface of the connector body and a side surface adjacent to the bottom surface.

In the connector according to an embodiment of the present invention, the region includes partial bottom surface and partial side surface of the connector body.

In the connector according to an embodiment of the present invention, the lead pins are bent to form an L-shaped structure in the region, in other embodiments, the lead pins can also be bent to form an inverted-hook or boot-shaped structure in the region.

In summary, the main characteristics of the connector of the present invention improves the design of the conventional lead pins by allowing lead pins to protrude from a bottom surface of a connector body and extending them to at least one side surface adjacent to the bottom surface to prevent disturbance of melted solder paste caused by the connector body and unevenness of the surface tension during actual SMT solder reflow processes, and to eliminate the occurrences of missing and poor solders or the connector falling off from the soldering point when later in use.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram illustrating soldering of a conventional connector;

FIG. 2 is a schematic diagram illustrating soldering of a connector according to the present invention;

FIG. 3 is a schematic diagram illustrating soldering of a connector in another embodiment according to the present invention; and

FIG. 4 is a schematic diagram illustrating soldering of a connector in yet another embodiment according to the present invention.

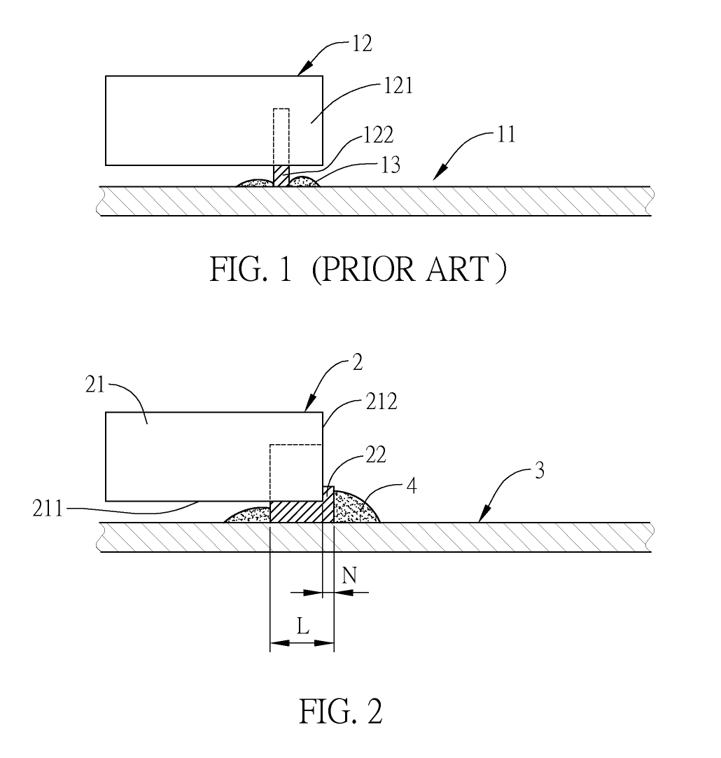

### DETAILED DESCRIPTION OF PREFERRED EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

Furthermore, the attached drawings are simplified to illustrate the basic concept of the present invention. Thus, only those elements that pertain to the present invention are shown and they may not necessarily be drawn in accordance to the actual number, size and shape. Rather, the form, number and ratio of the elements in practice may be arbitrarily varied, and the element layout may be more complicated.

Referring to FIG. 2, a schematic diagram illustrating a connector according to the present invention is shown. As shown, the present invention provides a connector 2 for being electrically connected to a circuit board 3 of a Bluetooth module. It should be noted that the connector of the present invention is not limited to be connected to the circuit board 3 of a Bluetooth module. The connector of the present invention may be connected to circuit boards having other functionalities. The connector 2 includes: a connector body 21 and a plurality of lead pins 22, each of which extends from the connector body 21 for being soldered onto the circuit board 3 of a Bluetooth module. For easy description of the structure of the lead pins 22, only one of the lead pins 22 is shown in FIG. 2 as an example.

The lead pin 22 protrudes from the bottom surface 211 of the connector body 21 and extending to a side surface 212 adjacent to the bottom surface 211. Specifically, by conforming to a region formed by the bottom surface 211 and the side surface 212 of the connector body 21, the lead pin 22 is bent to form an L-shaped structure, so that the lead pin 22 adheres to both the bottom surface 211 and the side surface 212 of the connector body 21. Compared to the conventional lead pin structure, the lead pin 22 has a certain extension length, so, during actual SMT solder reflow process, when melted solder paste 4 is to act upon the lead pin 22 of the connector 2, disturbance of the solder paste 4 by the connector body 21 is prevented, and uneven surface tension is avoided, and more solder paste 4 can be attached to the lead pin 22 of the connector 2.

In practice, when the connector body 21 is soldered onto the circuit board 3 of a Bluetooth module, the lead pin 22 has a thickness at the bottom surface 211 of the connector body 21 preferably equal to 0.4 mm, and another thickness at the side surface 212 of the connector body 21 preferably equal to 0.3 mm. However, it should be noted that, in different implementations, according to the condition shown in FIG. 2, assuming the thickness of the lead pin 22 on the circuit board of a Bluetooth module 3 is L, and the thickness at the side surface 212 of the connector body 21 is N, then the ratio of L to N can be between 2:1 to 5:1. This ensures the strength of the lead pin 22 at the bottom surface 211 of the connector body 21, but also guarantees that more melted solder paste 4 can be attached upon contacting with the lead pin 22.

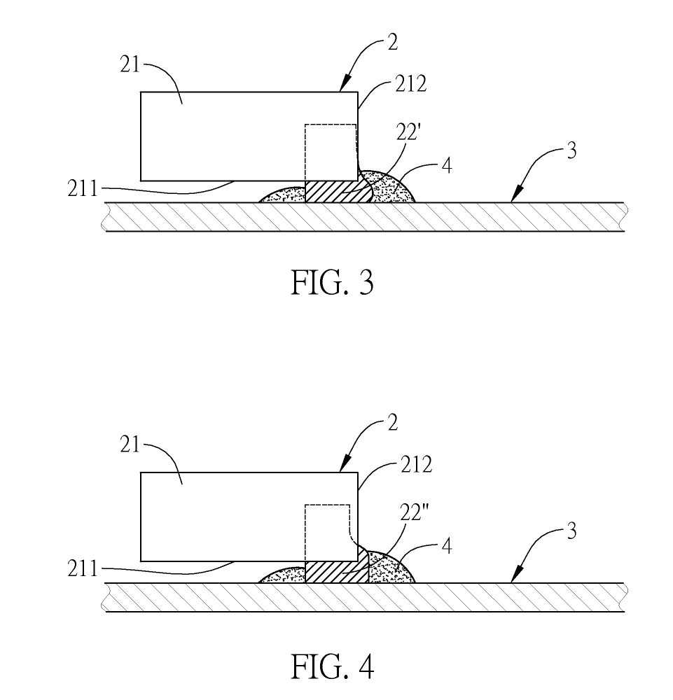

In other embodiments, the region formed by the lead pin 22 of the connector 2 on the bottom surface 211 and the side surface 212 of the connector body 21 can be in other forms, such as a boot-shaped structure of the lead pin 22′ shown in FIG. 3 or an inverted-hook structure of the lead pin 22″ shown in FIG. 4. In other words, any lead pin 22 of the connector 2 that extends from a region that includes both the bottom surface of the side surface of the connector body 21 is applicable to the present invention.

In summary, the connector according to the present invention improves the design of the conventional lead pins by allowing lead pins to protrude from a bottom surface of a connector body and extend to at least one side surface adjacent to the bottom surface, to prevent disturbance of melted solder paste caused by the connector body and unevenness of the surface tension during actual SMT solder reflow processes, and to eliminate the occurrences of missing and poor soldering or the connector falling off from the soldering point when later in use. Therefore, the present invention can overcome various drawbacks of the prior art and have high industrial values.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

1. A connector for connecting onto a circuit board, the connector comprising:
a connector body; and
a plurality of lead pins extending from the connector body for soldering onto the circuit board, the lead pins adhered to a bottom surface of the connector body and a side surface adjacent to the bottom surface.

2. The connector of claim 1, wherein the region includes a partial of the bottom surface and a partial of the side surface of the connector body.

3. The connector of claim 1, wherein the lead pins are bent to form an L-shaped structure in the region.

4. The connector of claim 1, wherein the lead pins are bent to form an inverted-hook structure in the region.

5. The connector of claim 1, wherein the lead pins are bent to form a boot-shaped structure in the region.

6. The connector of claim 1, wherein the circuit board is a circuit board of a Bluetooth module.

7. The connector of claim 1, wherein each of the lead pins has a bottom portion covering the bottom surface and a side portion covering the side surface, and the bottom portion has a bottom width two to five greater than a side width of the side portion.

8. The connector of claim 1, wherein each of the lead pins has a bottom thickness at the bottom surface equal to 0.4 mm, and a side thickness at the side surface equal to 0.3 mm.
